(19) United States
(12) Patent Application Publication
(10) Pub. No.: US 2025/0145230 A1
(43) Pub. Date: May 8, 2025

(54) HANDLE, COUPLING DEVICE AND VEHICLE

(71) Applicant: SAF-Holland, Inc., Muskegon, MI (US)

(72) Inventor: David W. Zaagman, Holland, MI (US)

(21) Appl. No.: 18/503,646

(22) Filed: Nov. 7, 2023

(51) Int. Cl. B62D 53/10

(52) U.S. Cl. CPC B62D 53/10

(57) ABSTRACT

The present invention relates to a handle, in particular a release handle, for a coupling device, in particular for a fifth wheel assembly, wherein the handle is configured to trigger a locking and/or opening of the coupling device, wherein the handle includes an end portion at a free axial end of the handle where at least the end portion of the handle is configured to actively emit light, and/or wherein the handle includes a signal portion that includes a light emitting element configured to emit a light signal, and/or wherein the handle includes a light guiding portion configured to guide light.

### BACKGROUND

The present invention relates to a handle, in particular for a coupling device, preferably for a fifth wheel coupling, a coupling device with such a handle and a vehicle.

In the prior art, handles to trigger a locking mechanism are used to lock coupling devices of vehicles, in particular trucks. It is known to use a light signal to passively illuminate the handle such that a driver or an operator may easily check the handle and the coupling device. However, the driver or the operator has to look very closely to check the coupling device and to make sure that the handle is in place and the coupling device is closed properly.

In view of this, it is found that a further need exists to provide an improved handle for a coupling device. In particular, a further need exists to provide a handle that allows a driver or an operator to easily check the state of the coupling device.

### SUMMARY

A first aspect of the present invention may relate to a handle, in particular a release handle, for a coupling device, in particular for a fifth wheel, wherein the handle is configured to trigger a locking and/or opening of the coupling device, wherein the handle may include an end portion at a free axial end of the handle, and wherein at least the end portion is configured to, in particular actively, emit light.

The handle includes the end portion. The end portion is at a free axial end of the handle. The end portion is a free axial end in the assembled state in a coupling device. The end portion of the handle is still visible to the driver of the vehicle or an operator, when checking the state of the coupling device. At least the end portion is configured to actively emit a light. Specifically, at least the end portion of the handle itself emits a light and the end portion is not illuminated passively.

A second aspect of the present invention may relate to a handle, in particular a release handle, for a coupling device, in particular for a fifth wheel, wherein the handle is configured to trigger a locking and/or opening of the coupling device, wherein the handle may include a signal portion, wherein the signal portion includes a light emitting element, which is configured to emit a light signal.

According to the second aspect, the handle may include a signal portion. The signal portion may be a section of the handle that is configured to be visible when the handle is in an assembled state in the coupling device. The signal portion may include a light emitting element. The light emitting element may be configured to emit a light signal. The light emitting element may be a light source or the light emitting element may be connected to a light source. It is possible that the signal portion includes multiple light emitting elements for a better light signal. Furthermore, the light emitting element may be configured to emit different light signals.

A third aspect of the present invention may relate to a handle, in particular a release handle, for a coupling device, in particular a fifth wheel, wherein the handle is configured to trigger a locking and/or opening of the coupling device, wherein the handle may include a light guiding portion which is configured to guide light.

According to the third aspect, the handle may include a light guiding portion. The light guiding portion is configured to guide light. The light guiding portion may extend along the handle at least partially or in sections, for example the light guiding portion may be arranged at an axial end. Preferably, the light guiding portion may extend along the whole handle. The light guiding portion may or may not extend visibly in the handle. The light guiding portion preferably includes a fiber optic material. The light guiding portion may connect the end portion and/or the signal portion with a light source.

Preferably, the end portion of the handle may correspond at least in sections to the signal portion of the handle. Alternatively, the end portion may completely correspond to the signal portion. The end portion and the signal portion preferably may include a light guiding portion at least in sections. In other words, the light guiding portion may form a part at least in sections of the end portion and/or the signal portion.

It is noted, the end portion, the signal portion and the light guiding portion may each form at least a part of each other. It is also noted that the end portion, the signal portion and the light guiding portion may be essentially identical.

Preferably, the handle is used to secure and release the locking mechanism of a coupling device. The coupling device is in particular of a fifth wheel. The handle can have different shapes. The handle may be configured to be manipulated or used by hand. That means that no additional tools may be required to trigger a locking and/or opening of the coupling device when using the handle. The handle is preferably arranged in the mounted state in such a way that it can be seen from the outside by a driver or an operator.

The handle may be configured to be arranged in a first position and a second position. The handle may be configured to be switched from the first position to the second position. In other words, the handle may be movable from the first position to the second position or vice versa. Further positions of the handle may be possible. Also, the first position may be described as a closed position and the second position may be described as an opened position. The closed position may be a position in which the coupling device is in a closed or secure state. The opened position may be a position in which the coupling device is in an opened or unsecure state.

The handle may be made of various materials. Preferably, the handle may include a metal and/or a plastic and/or a fiberoptic material. To generate a light signal, the handle may include a light source or be connected to the light source, for example via a light guide, which can be made from a fiberoptic material or which could include such a material.

The advantage of the handle is that the handle may be configured to actively provide a light signal depending on the status of the coupling device. For example, the handle may distinguish between a secured and unsecured status and/or an open or closed status of the coupling device. The handle may therefore improve the safety of the coupling device.

In an embodiment, the handle, in particular the end portion and/or the signal portion and/or the light guiding portion, includes at least partially a fiberoptic material, in particular glass fibers. Fiberoptic materials have the advantage of being cheap and easy to mount. Furthermore, fiberoptic materials may allow light to be easily transmitted from a light source to where it is needed or where the light should be emitted.

In an embodiment, the handle includes a channel portion, which at least partially extends along the handle in a longitudinal direction and wherein the fiberoptic material, in particular a fiberoptic cable, extends through the channel portion. The channel portion may extend on/from an outside surface of the handle. For example, the channel portion is configured as a groove. Additionally, at least two or more channel portions may extend along the handle, for example in multiple grooves, wherein each channel portion includes a fiberoptic material, in particular a fiberoptic cable.

In an embodiment, the handle includes a shaft portion and a handle portion, wherein at least the handle portion includes the end portion and/or the signal portion and/or the light guiding element. The handle portion may be described as the portion of the handle that is accessible to an operator or driver when mounted. The shaft portion may be described as the portion that is not accessible to an operator or driver when mounted. The shaft portion may interact with or may be coupled to a mechanism of the coupling device to trigger or achieve a locking and/or opening of the coupling device. It is possible that the handle portion and/or the shaft portion are configured to emit light. At least the handle portion may be configured to emit light. Preferably the handle portion and the shaft portion are integrally formed. In addition, or alternately, the handle portion and the shaft portion can form/realize different end portions of the handle.

In an embodiment, the shaft portion is configured to engage with a locking mechanism of the coupling device, wherein the shaft portion preferably extends essentially or substantially in a linear direction. The shaft portion may be designed to interact with the locking mechanism. The linear shape or geometry of the shaft portion allows easy positioning of the handle in the coupling device.

In cross-section, the handle, in particular the shaft portion, may have a substantially cylindrical or polygonal geometry.

In an embodiment, the handle portion includes at least one slope or angled portion so that the handle portion extends at least partially at an angle to the shaft portion. The slope or angled portion preferably includes an angle greater than 90° to the adjacent shaft portion. The handle portion may include multiple slopes such that a loop is formed. The loop may be formed at an axial end of the handle. The slope may allow an easier handling of the handle when moving the handle to the first position or the second position.

Alternatively, or in addition, the handle may include a grip element. The grip element may include a structure, for example a ball, that is arranged at the free axial end of the handle portion. The ball may be made of a synthetic material. The grip element may be used as a grip to move the handle from one position to another by hand.

In an embodiment, the handle is configured to indicate at least one condition of the coupling device by emitting a light. A first condition may be present when the handle is in an open position, for example pulled out, in which the coupling is open. Then, for example, the coupling device may be prepared to receive a king pin. A second condition may be present when the handle is in a closed position, for example pushed in, in which the coupling device is closed such that a coupling is provided. For example, a king pin may be arranged and secured in the coupling device. A third condition may be present when the handle is in a closed position, for example pushed in, but no coupling is provided. For example, a king pin may not be arranged in the coupling device. The coupling device may include sensors to detect the different conditions.

In an embodiment, the handle is included to emit light of different colors, wherein the different colors depend on the condition of the coupling device. That is, the handle may emit a yellow light when the first state is present and/or the handle may emit a green light when the second state is present and/or the handle may emit a red light when the third state is present. Alternatively, other colors are possible. For example, the first state may be associated with a white light.

Another aspect of the present invention relates to a coupling device, in particular a fifth wheel coupling, including a handle according to any one of the above embodiments. It should be noted that the coupling device is not limited to the fifth wheel coupling, but may also be any other type of coupling device, such as a jaw coupling, for example.

An additional aspect of the present invention relates to the usage of a handle in a coupling device, in particular in a fifth wheel.

Another aspect of the invention relates to a vehicle, in particular a truck, including a coupling device according to previous embodiment and/or a handle according to any of above embodiments.

### BRIEF DESCRIPTION OF THE DRAWINGS

In the following, the disclosure is described exemplarily with reference to the enclosed figures, in which

FIG. 1 is a top plan view of coupling device with a handle according to an embodiment of the present invention;

FIG. 2 is a perspective view of coupling device with a handle according to an embodiment of the present invention;

FIG. 3 is a bottom plan view of coupling device with a handle according to an embodiment of the present invention;

FIG. 4a is a top plan view of a handle according to an embodiment of the present invention;

FIG. 4b is a top plan view of a handle according to an embodiment of the present invention; and

FIG. 4c is a top plan view of a handle according to an embodiment of the present invention.

### DETAILED DESCRIPTION

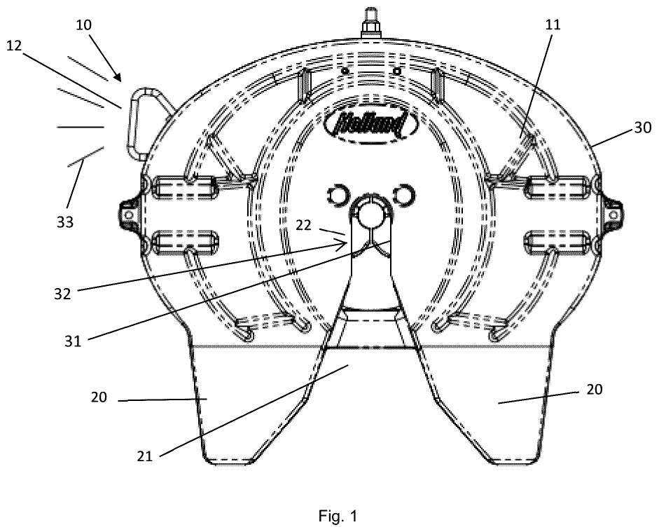

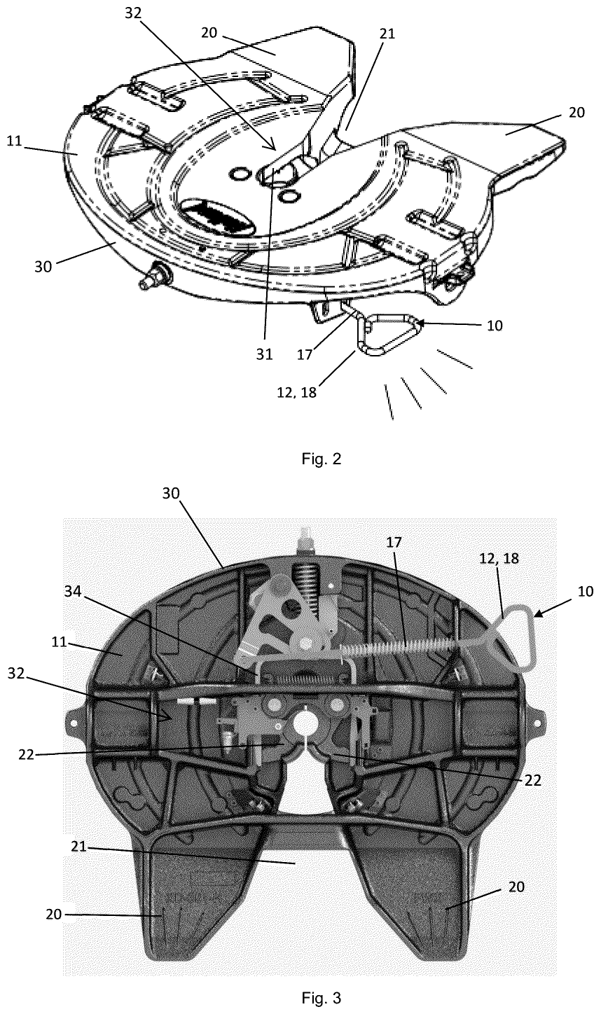

For purposes of description herein, the terms “upper,” “lower,” “right,” “left,” “rear,” “front,” “vertical,” “horizontal,” and derivatives thereof shall relate to the invention as oriented in FIGS. 1 and 2. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other characteristics relating to the embodiments disclosed herein are not to be considered as limiting, unless the claims expressly state otherwise.

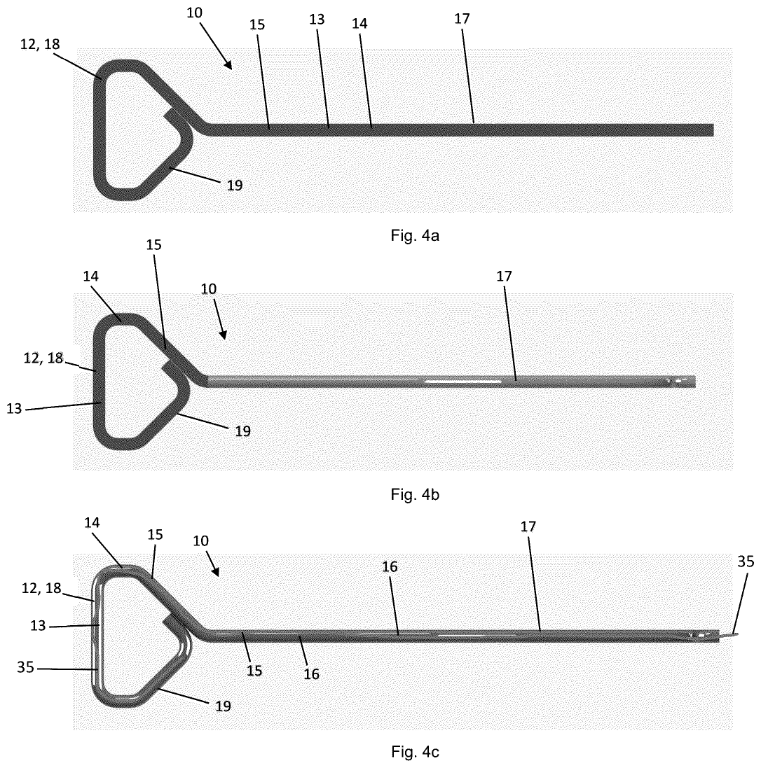

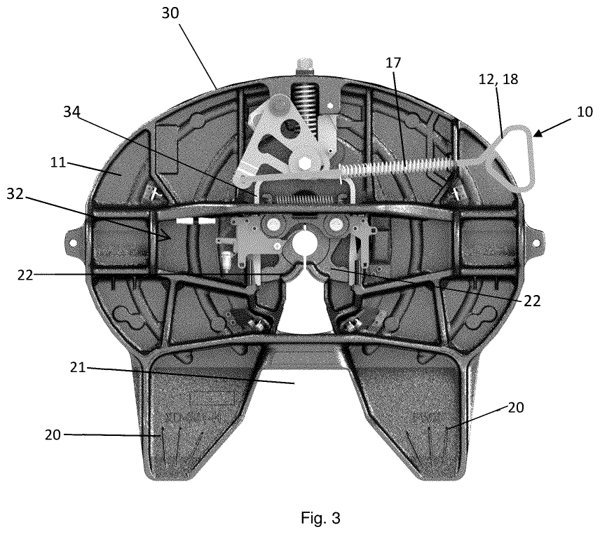

FIG. 1, FIG. 2 and FIG. 3 each show a coupling device 11 that may be part of a vehicle, in particular a truck or tractor. In the illustrated example, the coupling device 11 includes a fifth wheel assembly. It should be noted that the subject matter of the present invention is not limited to the use of the handle with a fifth wheel coupling, but may also be used with other coupling devices, including but not limited to a jaw coupling.

The fifth wheel assembly includes a fifth wheel hitch plate 30 that includes a top surface and a bottom surface. The top surface is shown in FIG. 1 and FIG. 2 and the bottom surface shown in FIG. 3. In a coupled state of the coupling device the top surface faces a trailer. The bottom surface includes a coupling mechanism to hold a king pin (not shown). In the illustrated example, the coupling mechanism is arranged on the bottom surface. The bottom surface and the top surface are arranged on opposite sides of the coupling device.

The fifth wheel hitch plate 30 has an oval geometry in a plain view. The oval geometry transitions into two horns or lead ramps 20, wherein the horns 20 are arranged opposite to each other.

An insertion portion or throat 21 is formed between the horns 20. The insertion portion 21 is configured to receive and to guide the king pin of a trailer to the coupling mechanism. The insertion portion 21 is essentially or substantially funnel-shaped in a plan view. The insertion portion 21 tapers towards an interior of the fifth wheel. More specifically, the insertion portion 21 tapers toward a central portion 31 of the fifth wheel. A coupling mechanism 32 is arranged in the central region 31 of the coupling device 11. In the coupled state, the king pin is arranged in the coupling mechanism 32. The funnel-shaped geometry of the insertion portion 21 allows an easy insertion of the king pin into the coupling mechanism 32.

In the example shown in FIGS. 1 and 2, a handle 10 is arranged on the side of the fifth wheel hitch plate 30 that includes the functional surface. The handle 10 includes a handle portion 18. The handle portion 18 is formed by a multiple bent portion of the handle 10 such that the handle portion 18 forms a grip configured to be grasped by an operator. The handle portion 18 may also be referred to as the end portion 12. The end portion 12 forms a free axial end of the handle 10.

The handle 10 is configured to actively emit a light signal. The light signal may be of from different colors. The color of the light signal may depend on the state of the handle 10 and/or the coupling device 11. The light signal is represented in FIG. 1 and FIG. 2 by the signal lines 33 in the area of the handle 10, in particular in the area of the handle portion 18.

FIG. 3 shows the interaction of the handle 10 with the coupling mechanism 32 of the coupling device 11. In FIG. 3, the fifth wheel is shown in a closed, i.e., coupled, state or condition. The king pin is not shown. The coupling mechanism 11 includes two retaining elements 22. The retaining elements or lock jaws 22 are preloaded with a spring force when coupled. The retaining elements 22 are held in position by a blocking element 34 and the handle 10. The blocking element 34 is U-shaped. When moving the handle 10 from a first position (closed position) to a second position (opened position), the blocking element 34 may be displaced so that the retaining elements 22 are moved into an opened state by the preloaded spring force.

In other words, the handle 10 is used to trigger an opening and/or locking of the coupling mechanism 32. That is, the handle 10 is used to secure and release the coupling mechanism 32 of the fifth wheel assembly 11. The handle 10 can have different shapes. As seen in the FIGS. 1 to 3, the handle 10 is arranged in the assembled state in such a way that the handle 10 can be seen from the outside by the driver or the operator.

The light signal 33, which is emitted by the handle 10, may be configured to indicate a predefined state of the coupling mechanism 32, for example not coupled or coupled. The driver of the vehicle or the operator may be informed of the state of the coupling device 32 by the light signal 33 of the handle 10. It is possible that the light signal 33 is only activated during one state. Alternatively, each state may include a different light signal, in particular a different color.

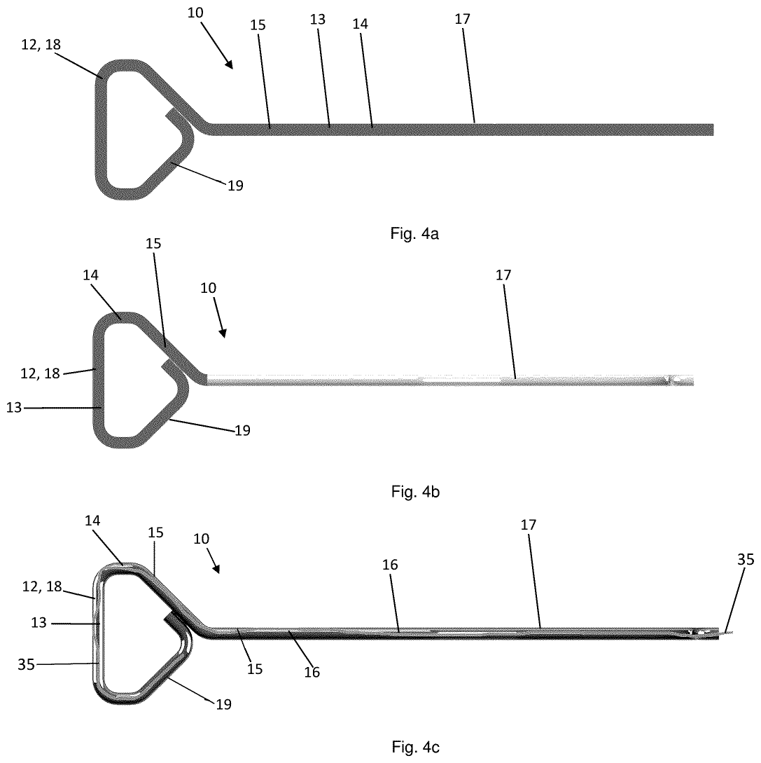

FIG. 4a, FIG. 4b and FIG. 4c each show a possible embodiment of a handle 10. The embodiments shown in the figures each have essentially the same geometry.

FIG. 4a shows an embodiment of a handle 10 made entirely of a light-conducting or light guiding material. This means that the entire handle 10 is configured to guide and/or emit a light, in particular a light signal. In other words, the entire handle 10 corresponds to a signal portion 13. Since the entire handle 10 emits a light signal, the entire handle 10 may also be referred to as a light emitting element 14. More specifically, the handle portion 18, which may also be described as an end portion 12, and the shaft portion 17 are configured to emit a light signal.

FIG. 4b shows the handle 10 with a shaft portion 17, which is preferably made of a metal or a synthetic material, in particular steel, and a handle portion 18 made of a fiber optic material. In this embodiment, the handle portion 18 is configured to emit a light signal. The handle portion 18 may include a light source or may be connected to a light source through the shaft element 17. The shaft portion 17 is configured to be durable. This is advantageous because it strengthens the shaft portion 17 and allows the shaft portion 17 to safely interact with the coupling mechanism 32 without being damaged. The handle portion 18 may be made entirely of a fiber optic material. This way, the handle 10 may generate a well visible signal. The handle portion 18 in this embodiment may also be described as signal portion 13 and light emitting element 14.

FIG. 4c shows a handle 10 with a milled slot i.e., a groove, notch or channel, in which one or more cables 35 including a fiber optic material are arranged. The handle portion 18 and the shaft portion 17 may be made of a metal or a synthetic material. A groove may extend along the handle 10. In the groove, the cable 35 is arranged with a fiber optic material. Alternatively, the handle 10 may include a plurality of such notches or grooves having fiberoptic cables 35. By doing this, the handle may produce a stronger light signal. Alternatively, each cable 35 may be configured to emit a different color of light depending on the state of the coupling device 11.

Other variations to the disclosed examples can be understood and effected by those skilled in the art in practicing the claimed subject matter, from the study of the drawings, the disclosure, and the appended claims. In particular, respective parts/functions of the respective example described above may also be combined with each other. In the claims, the words “comprising” and “including” does not exclude other elements or steps and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the claims. Further, it will be readily appreciated by those skilled in the art that modifications may be made to the embodiments described without from the concepts disclosed herein, and that such modifications are to be considered as included in the following claims, unless these claims by their language expressly state otherwise.

### REFERENCES

10 handle
11 coupling device
12 end portion
13 signal portion
14 light emitting element
15 light guiding portion
16 channel portion
17 shaft portion
18 handle portion
19 slope
20 horn
21 insertion portion
22 retaining elements
30 fifth wheel hitch plate
31 central portion
32 coupling mechanism
33 light signal
34 blocking element
35 cables

The invention claimed is:

1. A release handle for a vehicle coupling device, comprising:
at least one of an end portion at a free axial end of the release handle wherein the at least the end portion of the release handle is configured to emit light, a signal portion that includes a light emitting element configured to emit a light signal, and a light guiding portion configured to guide light; and
wherein the release handle is configured to trigger a locking and/or opening of the vehicle coupling device.

2. The release handle according to claim 1, wherein the end portion and/or the signal portion and/or the light guiding portion of the release handle comprises a fiberoptic material.

3. The release handle according to claim 2, wherein the fiberoptic material comprises glass fibers.

4. The release handle according to claim 2, wherein the release handle includes a channel portion that at least partially extends through the release handle in a longitudinal direction, and wherein the fiberoptic material extends through the channel portion.

5. The release handle according to claim 1, further comprising:
a shaft portion and a handle portion, wherein at least the handle portion comprises the end portion and/or the signal portion and/or the light guiding element.

6. The release handle according to claim 5, wherein the shaft portion is configured to engage with a locking mechanism of the coupling device, and wherein the shaft portion extends essentially in a linear direction.

7. The release handle according to claim 5, wherein the handle portion includes at least one slope such that the handle portion extends at least partially at an angle to the shaft portion.

8. The release handle according to claim 1, wherein the release handle is configured to indicate at least one condition of the coupling device by emitting a light.

9. The release handle according to claim 1, wherein the release handle is configured to emit light of different colors, wherein the color of the emitted light is dependent on the condition of the coupling device.

10. A vehicle coupling device, comprising the release handle according to claim 1.

11. The vehicle coupling device of claim 10, wherein the vehicle coupling device comprises a fifth wheel assembly.

12. A vehicle comprising the coupling device according to claim 10.

13. A release handle for a vehicle coupling device, comprising:
an end portion at a free axial end of the handle, wherein at least the end portion of the handle is configured to emit light, and wherein the release handle is configured to trigger a locking and/or opening of the coupling device.

14. A vehicle coupling device comprising the release handle according to claim 13.

15. The vehicle coupling device according to claim 14, wherein the vehicle coupling device comprises a fifth wheel assembly.

16. A release handle for a vehicle coupling device, comprising:
a signal portion that includes a light emitting element configured to emit a light signal, wherein the release handle is configured to trigger a locking and/or opening of the coupling device.

17. A vehicle coupling device comprising the release handle according to claim 16.

18. The vehicle coupling device according to claim 17, wherein the vehicle coupling device comprises a fifth wheel assembly.

19. A release handle for a vehicle coupling device, comprising:
a light guiding portion configured to guide lights, wherein the release handle is configured to trigger a locking and/or opening of the coupling device.

20. A vehicle coupling device comprising the release handle according to claim 19.

21. The vehicle coupling device according to claim 20, wherein the vehicle coupling device comprises a fifth wheel assembly.
